(19) United States
(12) Patent Application Publication
(10) Pub. No.: US 2017/0045158 A1
(43) Pub. Date: Feb. 16, 2017

(54) Guiding Aid for Guiding a Hose, Wire or Cable of Hand Tools to be Fastened to Clothing, and Combination of a Hand Tool and Such a Guiding Aid

(71) Applicant: Wood & Living, Callantsoog (NL)

(72) Inventor: Bastiaan Jan Mooij, Callantsoog (NL)

(21) Appl. No.: 15/307,974

(22) PCT Filed: Apr. 30, 2015
(86) PCT No.: PCT/NL2015/050289

§ 371 Date: Oct. 31, 2016

(30) Foreign Application Priority Data
May 1, 2014 (NL) 2012730

(51) Int. Cl. F16L 3/02; F16M 13/04; B25H 1/00; A45F 5/02

(52) U.S. Cl. CPC F16L 3/02; A45F 5/02; F16M 13/04; B25H 1/0021

(57) ABSTRACT

The invention relates to a guiding aid (10) for guiding a hose, wire and/or cable of a hand tool that can be worn on the clothing of a user. It comprises a clothing fastening part (12) and a guiding part (14). Preferably the clothing fastening part (12) comprises a back member (16) and a spaced apart supporting member (18), defining a receiving space (20) for receiving a clothing part and having an insert opening (22)at the lower end. The guiding part (14) comprises an eyelet (38) having a curved contact face (50) delimiting an inner region for receiving the hose and the like such that it can freely move through the eyelet. The eyelet has ends (42, 46), which define an access opening (40). The access opening (40) to the receiving inner region is directed upwards parallel or obliquely to the body of a user.

The invention relates to a guiding aid for guiding a hose, wire or cable of hand tools, which aid can be fastened to the clothing of a user, as well as to a combination of a hand tool and such a guiding aid.

A clamping aid for retaining an electrical cable, that can be worn by a user, is known from the technical field in question. For example, GB 2430233 has disclosed an electrical cable supporting and storing unit that comprises a belt clip to support the unit at waist height of a user. This known unit has an open topped plastic sleeve at a free end of a supporting arm, that is supported by a clasping arm. The clasping arm may also be used to store the electrical cable when it is not in use. This unit is used with garden equipment such as lawnmowers to stop the electrical cables from getting in the way of the user, thereby increasing safety.

U.S. 2003/0201287 has disclosed an electrical cord holding apparatus comprising a base portion having upper and lower sections. The base portion is positioned to be supported by material worn by a user. A flap portion is connected to the upper section of the base portion and extends generally parallel to the base portion in a spaced apart relationship. A clip portion such as a bent strip in the shape of the letter “S” is connected to the flap portion. A lower section of the clip portion together with the flap portion forms a region for supporting and restraining a line so as to fit snugly a line, such as an electrical extension cord, used in combination with an electric garden tiller. The clip portion is able to flex away from the flap portion in response to the insertion of a line into the supporting and restraining region. A lower section of the base portion extends beyond the front portion. At the extended part thereof a projection shoulder is provided.

From U.S. Pat. No. 2,136,855 a flashlight holder for receiving and securing a flashlight at various places on the person of the user is known. The holder is constructed from a pair of flat resilient members looped upon themselves to provide companion jaws and relatively thick handles extending therefrom. Rearwardly extending portions formed on these jaws between the handles are provided with slots, through which a split spring ring extends for urging and holding the jaws in clamping association. A substantially U-shaped spring collar is formed on one of the handles for receiving and holding a flashlight.

A hanger for carrying, holding and securing hand tools and the like is known from U.S. 2011/0253759 A1. The hanger is made from a pliable material, which may be adjusted, modified, shaped and reshaped by the user to hold and secure the particular shape of the respective tool.

DE 19835264 A1 has disclosed a clamping device for holding a feeding tube of a liquid supply system in position in relation to the user. This clamping device comprises a rotatable clamping arm, which is designed such that a first part of the clamping arm fastens a clothing part while a second part clamps the feeding tube.

Due to legislation nowadays, in their workshops professional carpenters, whitesmiths, tilers and the like use hand tools, which use either a supply hose for pressurized air connected to a suitable pressurized air supply system or a drain hose for removing e.g. (saw)dust, metal particles, sharps and other debris, which hose is connected to a suitable, often mobile discharging or collecting system such as a suction pump having a dust collection filter, which may rest on the floor. Contrary thereto stationary tools have their own dedicated pressurized air and/or suction system usually located above the tool at a stationary position, e.g. depending from the ceiling. Commonly such a supply hose and/or drain hose of a hand tool have a diameter far larger than a typical electrical cord and are less flexible. Moreover, the outer periphery of a drain hose typically has a ribbed surface, which can hook behind an edge of a working table, a ruler or the work piece itself, that is being treated. This complicates working with such a hand tool, in particular if long strokes or complex movements are to be made with the hand tool, thereby reducing productivity, comfort and accuracy. Also safety plays an important role as the hoses might get in the way of the user of the hand tool or other persons moving around in the workshop.

The holding aids for electrical cords known from the above prior art are not suitable for holding these hoses, as these aids are based on clamping the electrical cable. E.g. U.S. 2003/0201287 teaches to have a slack portion of the electrical cord between the holding apparatus and a plug at the garden tiller. A similar slack portion of a less flexible hose would seriously hamper the user's movements and accuracy.

Therefore there is a need for providing a guiding aid for hoses, in particular drain hoses having a ribbed surface, which guiding aids can be easily worn by a user, that improve safety,

An object of the present invention is to provide such a guiding aid, or at least a suitable alternative.

According to a first aspect of the invention a guiding aid for guiding a hose, wire and/or cable of a hand tool is provided, which guiding aid can be worn on the clothing of a user, and comprises a clothing fastening part for fastening to the clothing, in particular a belt, and a guiding part for guidance of the hose, wire and/or cable, wherein the guiding part comprises an open guiding eyelet for receiving the hose, wire and/or cable such that it can freely move in a region delimited by the eyelet, the open eyelet having a proximal end close to the clothing fastening part and a distal end, which ends delimit an access opening for providing access of the hose, wire and/or cable to the region delimited by the eyelet, and wherein the eyelet—as seen in cross section has a curved contact face, wherein the eyelet is fastened to the supporting member at a fastening position, and the proximal end of the open eyelet is positioned at an equally high or lower position with respect to the distal end as seen in the height direction of the clothing fastening part.

The guiding aid according to the invention is particular suitable for guiding a hose. However, it will function as well with an electrical cord, cable or other type of line. In the description to follow the emphasis will be on guiding a hose. When the guiding aid is not being used for guiding a hose, it is also suitable for temporarily carrying/storing all kind of hand tools, like a (battery/power/hand operated) screwdrivers, injector, hammer and the like.

The guiding aid according to the invention comprises two main parts, that is to say a clothing fastening part and a guiding part.

Preferably the clothing fastening part comprises a back member and a spaced apart supporting member, which at least at the upper ends thereof are connected to one another, defining a receiving space or gap for receiving a clothing part, such as a belt in loop of a pant or overall. Preferably the clothing fastening part, in particular the back member and supporting member have an insertion opening that opens into the receiving space, for the clothing at the lower end opposite to the upper end. This allows for a quick insertion and removal of the clothing from the clothing fastening part, whether the clothing is a belt, the upper band or a pocket of trousers. In the preferred embodiment the clothing fastening part itself comprises a back member, during use positioned closest to the user, and a supporting member for connection to the guiding part. The back member and supporting member are spaced apart, preferably parallel spaced apart. At the upper end the back member and the supporting member are connected to one and another by connecting material, thereby forming a kind of connecting bridge. Advantageously the upper and lower ends of the members are curved allowing smooth insertion of the clothing part and the hose and the like, as will be explained hereinbelow. This also improves the wearing comfort for the user. At the opposite lower end the clothing fastening part has an insert opening for insertion of the piece of clothing by which the guiding aid itself is to be carried. Typically the guiding aid is positioned at the waist of the user by a belt, although carrying by an upper board of trousers, a trouser pocket, an overall, a harness or jacket and the like is possible as well. Advantageously it is positioned at one of the hips, so that the hose, cord or cable is guided to a position behind the user offering freedom of movement, comfort and safety. Both members and the bridging material, preferably in combination with a projection shoulder projecting from the back member to the supporting member define a receiving space or gap for receiving the clothing part, in particular a belt, to which the guiding aid is attached. Preferably the projection shoulder has a sloping face sloping upwardly from the insert opening towards the receiving space or gap and a shoulder face perpendicular to the back member. The sloping face facilitates insertion of the piece of clothing and flexing of the back member, while the shoulder face prevents the clothing part from being accidentally released from the guiding aid. The back member can flex away from the supporting member allowing insertion and withdrawal of the clothing part.

The guiding part is connected to the clothing fastening part, preferably the face of the supporting member that is opposite to the face thereof facing the receiving space or gap, e.g. by means of a connecting arm. The guiding part comprises an open eyelet which defines an inner receiving region, and has an access opening to the inner receiving region between the proximal and distal ends of the eyelet for passing radially a hose, cord or cable into the inner receiving region of the eyelet. The inner periphery of the eyelet defines this inner receiving region for receiving the hose, cord or cable in a manner enabling a sliding movement thereof. In other words the dimensions of this inner receiving region are wider than the outer periphery of the hose, cord or cable being handled thereby allowing a sliding engagement contrary to a clamping engagement as known from the prior art holding devices. As commonly a suction hose has a ribbed outer surface, the inner periphery of the eyelet, that is to say the contacting face that comes into contact with this outer hose surface, is also curved, such as semi-circular, viewed in cross section, allowing the hose to slide smoothly back and forth over this contacting face through the eyelet. Advantageously the width of the eyelet is larger, e.g. 10 mm or more, such as 20 mm, than the distance between adjacent ribs of the hose to ensure smooth sliding of the hose. It will be understood that the inner region of the eyelet may adopt many shapes provided that the hose is able to slide, such as a polygonal, elliptical or circular. A circular eyelet (except at the position of the access opening) is preferred. The access opening is such that the proximal end of the open eyelet is at a position equally high as or lower than the distal end having the effect that the access opening is directed upwards and preferably obliquely to the user's body during use and thus that the hose is to be introduced into the inner receiving region from above and along the body of the user. Thus the access opening can only accessed from above by the hose. To put it differently, in a side view (in the direction of sliding movement of the hose) the access opening is preferably positioned in the second quadrant (applying the common mathematical definition by dividing a plane by means of x- and y- axis and counting quadrants with the first quadrant from angle 0° in anti-clockwise direction). Optionally the device according to the invention may have an introduction part, e.g. a channel or a chute having an inlet, the outlet of which is connected to the access opening.

The access opening of an essentially circular (except for the access opening) eyelet, which is a preferred embodiment, can be defined as the shortest distance between the opposing ends of the open eyelet, is positioned such that it is directed (taken as the line perpendicular to the imaginary line connecting the ends of the open eyelet) obliquely and upwardly to the body of the user (imaginary upward extension of the clothing fastening part, in casu supporting member). Advantageously, at least the distal end of the eyelet that is remote from the clothing fastening part or supporting member thereof—compared to the proximal end of the end of the eyelet closest to the clothing fastening part—extends above the upper end of the clothing fastening part. If a hose or the like is positioned in the eyelet, it cannot escape therefrom through the access opening, even when the hose or the like sticks behind another object.

Preferably the proximal end of the eyelet is directly connected to the clothing fastening part, such as to the supporting member thereof. This configuration makes this proximal end of the eyelet less vulnerable to damage during use and ensures that forces exerted on the eyelet are transferred to the clothing fastening part. Moreover it allows an easy introduction of the hose. In an advantageous embodiment the connection is at a level near or higher than the top of the clothing receiving space or gap of the clothing fastening part. In this position the guiding part is firmly supported by the extra material forming the bridge between the back member and support member. This configuration has also the effect that the leverage due to the weight of a hose or the like is small, thereby improving comfort to the user. Advantageously, in view of easy insertion of and prevention of damage to the hose the free end of the eyelet, in particular the distal end, or tip thereof is rounded, such as ball shaped. More preferably this free end extends slightly outwards for the same purpose. Preferably the connecting (proximal) end of the eyelet is curved as well. Advantageously, the supporting member extends above the connecting position of the eyelet such that the distance between the upper end of the clothing fastening part such as the supporting member and the free (distal) end of the eyelet is similar to the size of the access opening.

In a further embodiment the clothing fastening part, preferably the supporting member thereof and an adjacent outer peripheral part of the eyelet together define a clamping region for a cord or cable in order to increase safety. Preferably the clothing fastening part has a ribbed or wavy area at the clamping region providing a number of differently sized clamping positions for clamping electrical cords or cables, which themselves may have different diameters, such as 6, 7 or 8 mm. For clamping use is made of the intrinsic resilience of the eyelet due to its design and material, also allowing clamping of slightly larger diameter cords.

In a preferred embodiment the eyelet circumference corresponds to at least 270° of a circle.

The eyelet is preferably made of a resilient material like a plastic such as polyethylene or polypropylene, so that it can flex sufficiently allowing increasing the size of the access opening and thus allowing introduction of a hose radially through the access opening into the inner region. Advantageously the guiding aid according to the invention is made as one piece, in other words as an integral article, without any mechanically fastening means like bolts, screws, springs and the like, because such means are more sensitive to failure or breakage.

According to a second aspect of the invention a combination of a hand tool provided with a hose and a guiding aid according to the first aspect of the invention is provided. The advantages of the guiding aid as discussed above are similarly applicable to this combination. Likewise the various preferred and advantageous embodiments of the guiding aid apply to the combination. Examples of such hand tools include, but are not limited to, electrical saws like a buss saw or jig saw, a cutter such as a domino cutter or side cutter, electrical planing tool, drills, grinders and sanders. Also use of the guiding aid with hand tools like garden equipment, e.g. a garden hose, leaf blower or mower is contemplated.

In a preferred embodiment of the combination the inner receiving region delimited by the inner periphery of the eyelet has a cross section larger than the outer diameter of the hose. Commonly for commercially available professional hand held tools the hose outer diameter is in the range of 25-30 mm for a small sized diameter hose, about 32-38 mm for a medium sized diameter hose and about 42-48 mm for a large sized diameter hose. The cross section of the eyelet is correspondingly in the range of 100 -250% of the hose outer diameter, such as about 65 mm, which is universally suitable for all these hoses. The guiding aid is particularly useful for the medium and large sized diameter hoses. In the combination, the access opening has a width smaller than the hose diameter, such as about 60-100% of the hose diameter, e.g. 30-35 mm.

The invention is further illustrated by means of the attached drawing, wherein:

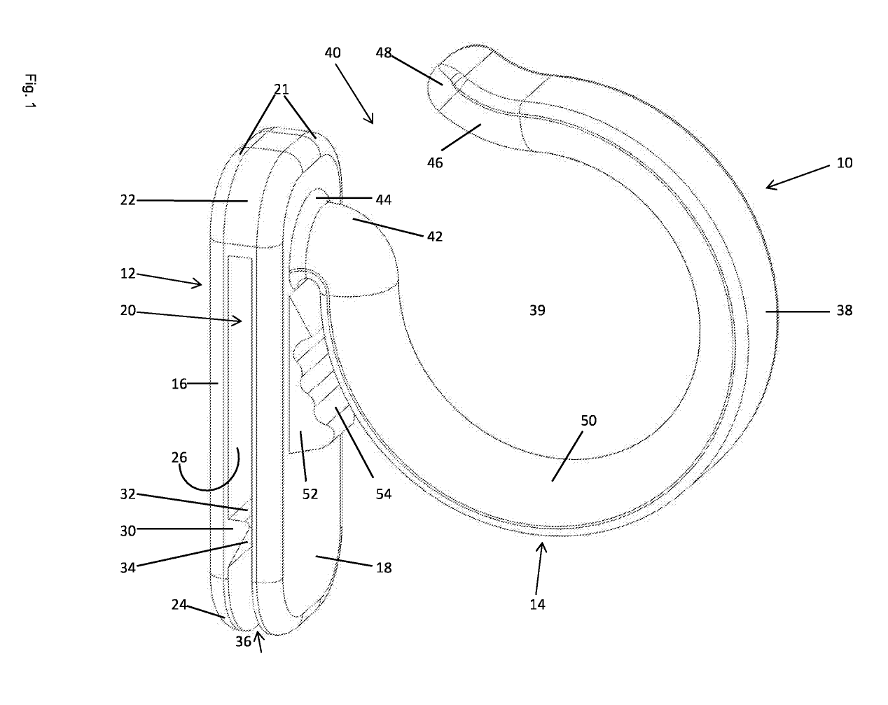

FIG. 1 shows a perspective view of an embodiment of a guide aid according to the invention; and

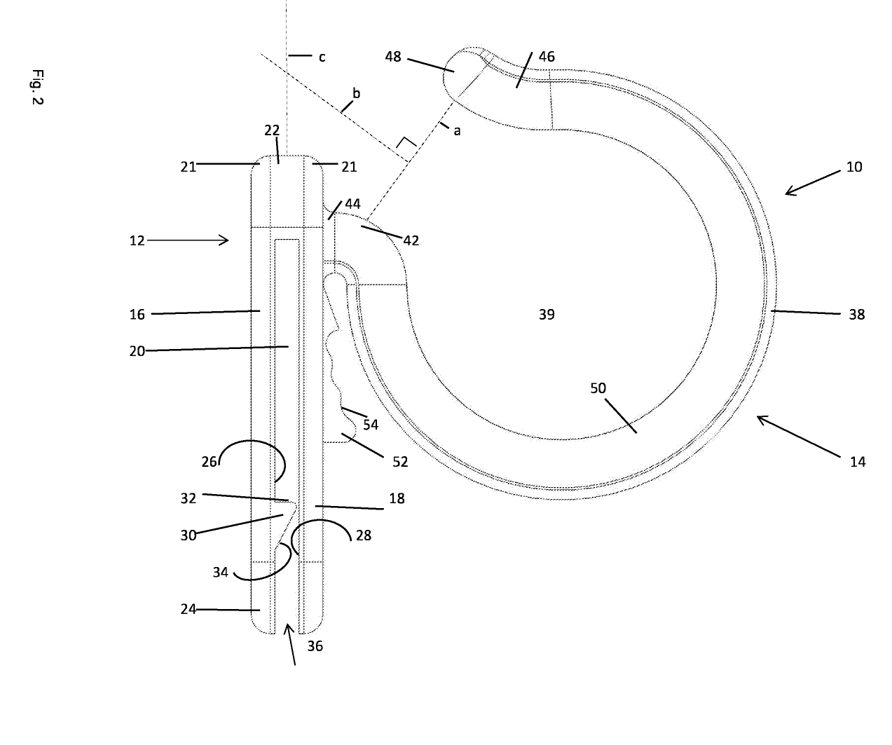

FIG. 2 shows a side view of the embodiment shown in FIG. 1.

In the drawing equal components of the guiding aid according to the invention are identified by the same reference numeral.

FIG. 1 shows a perspective view of an embodiment of a guiding aid according to the invention, which is indicated in its entirety by reference numeral 10. The guide aid 10 comprises a clothing fastening part 12, such as a belt clip, and a guiding part 14. In this embodiment the clothing fastening part 12 comprises a back member 16, e.g. about 40 mm wide and 100 mm long, and an equally sized supporting member 18, which is spaced apart from the back member 16 leaving free a gap or receiving space 20. At the upper ends 21 the members 16 and 18 are connected by bridging part 22. Near the lower end 24 (but spaced from the lower tip) of inner face 26 of the back member 16 (facing the opposite inner face 28 of the supporting member 18) a shoulder projection 30 is provided having a flat upper face 32 and a sloping face 34. The space between the ultimate lower ends 24 of both members 16 and 18 creates an insertion opening 36 for a piece of clothing worn by a user, like a belt. As the shoulder projection 30 is positioned inwards from the insertion opening 36 said piece is easily directed in the insertion opening 36. The sloping face 34 facilitates smooth introduction of the said piece beyond the shoulder projection 30 into the receiving space or gap 20. The height and width thereof are typically designed such that a standard sized belt as worn by craftsmen fits freely in the gap allowing sliding of the guiding aid over the belt. For example the height of the gap is about 55 mm and the gap width is about 5 mm. The guiding part 14 comprises an open eyelet 38 having an access opening 40 for introduction of a hose (not shown) and encloses an inner region 39. In this embodiment a first connecting (proximal) end 42 of the eyelet 38 merges into a connecting arm 44, which extends essentially perpendicular to the supporting member 18. The eyelet 38 defines an inner receiving region 39 for receiving the hose. The eyelet 38 describes an arc of a circle over 270°. The access opening 40 is defined by the connecting end 42 and the free (distal) end 46 of the eyelet 38. As can be seen the tip 48 of the free end 46, which projects slightly outwardly, has a curved surface. Likewise the surface of the connecting end 42 is rounded. The eyelet 38 has a width of about 20 mm, which is wider than the distance between adjacent ribs, if any, of hoses of professional hand tools, which hoses are commonly used for sucking away rest material of a work piece. The eyelet 38, as viewed in cross section, has a curved contacting surface 50 enabling smoothly gliding of the hose through the eyelet 38 without being stuck. Below the position of the connecting arm 44/first connecting end 42 the supporting member 18 is provided with a clamp 52 having a ribbed face 54 for retaining an electrical cord (not shown). Depending on the difference between the hose diameter and the diameter of the open eyelet 38 and thus the non-occupied region such a cord could also be introduced in the eyelet 38 itself.

FIG. 2 also shows the width a of the access opening 40 as the shortest distance between the ends 42 and 46 of the eyelet 38 and a line b perpendicular to this width a. This line b represents the direction of the access opening 40. As can be seen this line b intersects the extension line c above the upper ends 21 of the supporting member. As said in this preferred embodiment the eyelet 38 is an arc of a circle of approximately 285°, and consequently the access opening is positioned in the second quadrant and is smaller than 90°.

1. Guiding aid for guiding a hose, wire and/or cable of a hand tool, which guiding aid can be worn on the clothing of a user, comprising:
a clothing fastening part for fastening to the clothing, the clothing fastening part having a height direction; and
a guiding part for guidance of the hose, wire and/or cable comprises an open guiding eyelet for receiving the hose, wire and/or cable such that it can freely move in a region delimited by the open guiding eyelet:
wherein the open guiding eyelet has a proximal end close to the clothing fastening part and a distal end which ends delimit an access opening for providing access of the hose, wire and/or cable to the region delimited by the open guiding eyelet;
wherein the open guiding eyelet—as seen in cross section in a plane parallel to a back and forth sliding movement of the hose, wire and/or cable through the open guiding eyelet during use—has a curved contact face;
wherein the open guiding eyelet is fastened to the clothing fastening part at a fastening position; and
wherein the proximal end of the open guiding eyelet is positioned at an equally high or lower position with respect to the distal end as seen in the height direction of the clothing fastening part.

2. The guiding aid according to claim 1, wherein the access opening has a direction, defined as the direction of a line perpendicular to an imaginary line representing the shortest distance between the ends, which crosses an imaginary upwardly oriented extension of the clothing fastening part.

3. The guiding aid according to claim 1, wherein the clothing fastening part comprises a supporting member and a spaced apart back member, which are connected to one another at least at their upper ends and define a receiving gap for receiving a clothing part.

4. The guiding aid according to claim 3, wherein the lower ends of the back member and the supporting member define a insertion opening for insertion of a clothing part.

5. The guiding aid according to claim 1, wherein the proximal end of the open guiding eyelet is connected to the clothing fastening part.

6. The guiding aid according to claim 3, wherein the fastening position is at the top end of the receiving gap.

7. The guiding aid according to claim 1, wherein a free end of the open guiding eyelet is rounded.

8. The guiding aid according to claim 1, wherein a free end of the open guiding eyelet comprises an insertion part extending away from the open guiding eyelet.

9. The guiding aid according to claim 1, wherein the clothing fastening part and an adjacent outer peripheral part of the open guiding eyelet define a clamp.

10. The guiding aid according to claim 9, wherein the clothing fastening part is provided with a ribbed clamping face.

11. The guiding aid according to claim 1, wherein the open guiding eyelet comprises a circle arc of at least 270°.

12. The guiding aid according to claim 1, made in one piece.

13. An assembly of a hand tool having at least a hose and a guiding aid, which can be worn on clothing, according to claim 1.

14. The assembly according to claim 13, wherein the area delimited by the open guiding eyelet has a cross-section that is larger than the diameter of the hose, wire and/or cable.

15. The assembly according to claim 13, wherein the clothing fastening part comprises a supporting member and a spaced apart back member, which are connected to one another at least at their upper ends and define a receiving gap for receiving a clothing part; and
wherein the receiving gap has dimensions smaller than the diameter of the hose.

16. The guiding aid according to claim 1, wherein the proximal end of the open guiding eyelet is connected to the supporting member.
